(19) United States
(12) Patent Application Publication
(10) Pub. No.: US 2009/0052909 A1
(43) Pub. Date: Feb. 26, 2009

(54) OPTICAL COMMUNICATION MODULE AND OPTICAL SIGNAL TRANSMISSION METHOD

(75) Inventors: Tomoyuki Hino, Tokyo (JP); Kazuhiko Kurata, Tokyo (JP); Yutaka Urino, Tokyo (JP); Ichirou Ogura, Tokyo (JP); Junichi Sasaki, Tokyo (JP); Youichi Hashimoto, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/814,462

(22) PCT Filed: Jan. 21, 2006
(86) PCT No.: PCT/JP2006/300841

§ 371 Date: Jul. 20, 2007

(30) Foreign Application Priority Data
Jan. 21, 2005 (JP) 2005-014119

(51) Int. Cl. G02B 6/28; H04B 10/12

(52) U.S. Cl. 398/200; 385/146

(57) ABSTRACT

One or more one-dimensional array-shaped photoelectric conversion modules 302 are mounted on a board 301. A one-dimensional array-shaped light receiving/emitting element 303 is mounted in each of the one-dimensional array-shaped photoelectric conversion modules 302. Further, the one-dimensional array-shaped photoelectric conversion modules 302 are mechanically and optically connected to a flexible fiber sheet 306 through an optical connector 305. As parallel transmission paths 306 from the one-dimensional array-shaped photoelectric conversion modules 302 approach an end of a board 301, they are laminated with each other and connected to a two-dimensional array-shaped optical connector 307 at an end of the board. Further, a wavelength multiplexer/demultiplexer is connected to the optical connector.

### TECHNICAL FIELD

The present invention relates to an optical communication module between devices, between boards or on backplane of information equipment such as a router, a server or a storage, and to an optical signal transmission method.

### BACKGROUND ART

Recently, as the amount of information handled by information equipment such as a router, a server or a storage dramatically increases, the limit of electric transmission in interconnection between devices, between boards or on backplane of the information equipment has become evident, and thus needs for interconnection using optical transmission, in particular, parallel optical interconnection using a plurality of optical transmission paths or wavelength multiplexing interconnection using a plurality of wavelengths have been increased. To cope with the needs, there have been developed array light interfaces for the interconnection.

As a conventional example of the wavelength multiplexing interconnection module using the plurality of wavelengths, there is known the arrangement shown in FIG. 2 of Non-Patent Document 1, and FIG. 16 shows an arrangement of the module. A different 8-channel VCSELs (Vertical Cavity Surface Emitting Lasers) 200 having a 850 nm band and wavelength intervals of about 12 nm (shown by a dot line in the figure) are disposed under a module. The module includes an optical coupler 201 on which the light from the VCSEL 200 is incident, a filter block 202 composed of eight dielectric multilayer films and disposed above the optical coupler 201, and an optical connector 203 on which the light from the filter block 202 is incident. The light emitted from the respective VCSELs and modulated at 1.25 Gbps is collimated by the optical coupler 201, and reflected and transmitted by the multilayer films of the filter block 202 so that the light can be multiplexed and demultiplexed.

Note that as technologies relating to the present invention, Patent Document 1 discloses a face-emitting laser disposed in an array state, a photo detector, and an optical transmission path connected thereto, and Patent Document 2 discloses two-dimensional array-shaped optical connector.

Non-Patent Document 1: 2001 Electric Component and Technology Conference “Low Cost CWDM Optical Transceivers” Eric B. Grann

Patent Document 1: Japanese Patent Application Laid-Open Publication No. 2001-42171

Patent Document 2:Japanese Patent Application Laid-Open Publication No. 09-133842

### DISCLOSURE OF THE INVENTION

However, in the wavelength multiplexing interface module shown in Non-Patent Document 1, it is contemplated that use of the multiwavelength monolithic integrated VCSEL that is collectively grown on the same substrate as a light source causes a significant technical disadvantage as to a resonant wavelength control, a gain peak wavelength and a light emission diameter control, and it is difficult to reduce a cost by using it. When, for example, the multiwavelength monolithic integrated VCSEL that is collectively grown on the same substrate is used, an disadvantage in production arises. That is, when a gallium arsenide (GaAs) substrate is used as the substrate, although it is required to control the thickness and the composition of the respective films of an aluminum gallium arsenide multilayer film on the substrate for the resonant wavelength control and the gain peak wavelength control (for example, it is necessary to form a multilayer film whose aluminum composition is controlled for the resonant wavelength control), it is not easy to control the aluminum composition. Further, the wavelength multiplexing interface module is also defective in operation in that it has no substitutability. That is, if one element is broken in a VCSEL device, the substrate must be entirely replaced.

An object of the present invention is to provide an array light interface module for a wavelength multiplexing interconnection using a plurality of wavelengths that can solve the above disadvantages as well as can enhance the degree of freedom of disposition of optical devices, can have substitutability, can reduce electric crosstalk between optical devices and can prevent deterioration of the optical devices due to heat.

According to a first aspect of the present invention, there is provided an optical communication module including a plurality of one-dimensional array-shaped photoelectric conversion modules, a plurality of light transmission members optically connected to the plurality of one-dimensional array-shaped photoelectric conversion modules, and a two-dimensional array-shaped optical connector whose one connector end is optically connected to the plurality of light transmission members, wherein the plurality of one-dimensional array-shaped photoelectric conversion modules correspond to optical signals having respective different wavelengths, and the other connector end of the two-dimensional array-shaped optical connector is optically connected to a wavelength multiplexer/de multiplexer.

According to a second aspect of the present invention, there is provided an optical signal transmission method including the steps of demultiplexing an optical signal having a different wavelength by a wavelength multiplexer/demultiplexer optically connected to one connector end of a two-dimensional array-shaped optical connector, and outputting the demultiplexed outputs from the other end of the two-dimensional array-shaped optical connector to a plurality of one-dimensional array-shaped photoelectric conversion modules.

According to a second aspect of the present invention, there is provided an optical signal transmission method including the steps of inputting optical signals having a different wavelength from a plurality of one-dimensional array-shaped photoelectric conversion modules to one end of a two-dimensional array-shaped optical connector, and modulating the optical signals by a wavelength multiplexer/demultiplexer optically connected to the other end of the two-dimensional array-shaped optical connector and outputting the modulated optical signal.

Note that the one-dimensional array-shaped photoelectric conversion module includes each light receiving element for converting an optical signal into an electronic signal, each light emitting element for converting an electronic signal into an optical signal, or each device composed of a mixture of a light receiving element and a light emitting element, these devices being arranged in a one-dimensional array state. That is, the photoelectric conversion module may be composed of only the light receiving elements, only the light emitting elements, or only the devices that each is composed of the mixture of the light receiving element and the light emitting element. However, it may include the other devices such as an IC driver.

In the present invention, the photoelectric conversion module has a one-dimensional array shape that has a high degree of freedom of layout and is excellent in substitutability. Optical signals having a different wavelength are output from the plurality of photoelectric conversion modules to the two-dimensional array-shaped optical connector and further multiplexing functions are put together by optically connecting the wavelength multiplexer/demultiplexer to the two-dimensional array-shaped optical connector, thereby a multiplexed optical signal is output.

Further, demultiplexing functions are put together by optically connecting the wavelength multiplexer/demultiplexer to the two-dimensional array-shaped optical connector. Multiplexed light is separated for each wavelength and output to the plurality of one-dimensional array-shaped photoelectric conversion module that has a high degree of freedom of layout and is excellent in substitutability.

### EFFECT OF THE INVENTION

According to the present invention, since the mounting shape in a photoelectric conversion module is a one-dimensional shape, the layout of the photoelectric conversion modules can be optionally determined on a board (substrate), and the photoelectric conversion modules can be replaced in a unit of one-dimensional array. Since each of the one-dimensional array-shaped photoelectric conversion modules can be disposed with flexibility, the one-dimensional array-shaped photoelectric conversion modules can be designed with a high degree of freedom in consideration of electric crosstalk and heat dissipation. When it is intended to transmit optical signals in parallel, the light emitting element and/or the light receiving element, which can be made accurately at a low cost, can be mounted without using a monolithic integrated multiwavelength light emitting element and/or a monolithic integrated multiwavelength light receiving element, whose realization of them is difficult.

Further, it is possible to put the wavelength multiplexing/demultiplexing functions together by optically connecting the wavelength multiplexer/demultiplexer to the two-dimensional array-shaped connector.

### BRIEF DESCRIPTION OF THE DRAWINGS

FIG. 1 is a perspective view of an overall optical communication module as an embodiment of the present invention;

FIG. 2 is a perspective view of a one-dimensional array-shaped photoelectric conversion module 308-1;

FIG. 3 is a sectional view of the one-dimensional array-shaped photoelectric conversion module 308-1;

FIG. 4 is a perspective view of a two-dimensional array-shaped optical connector 307;

FIG. 5 is a perspective view of a wavelength multiplexer/demultiplexer 311 making use of a multilayer film filter 313;

FIG. 6 is an arrangement view an overall optical communication module from which the optical connector 307 is removed;

FIG. 7 is a sectional view of the overall optical communication module from which the optical connector 307 is removed;

FIG. 8 is a top view of the overall optical communication module;

FIG. 9 is a flowchart showing an optical signal transmission method of generating optical signals having a different wavelength, multiplexing the optical signals and outputting them;

FIG. 10 is a flowchart showing an optical signal transmission method of demultiplexing a multiplexed optical signal and outputting the demultiplexed optical signals to a one-dimensional array-shaped photoelectric conversion module;

FIG. 11 is a perspective view showing a case in which photoelectric conversion modules are disposed on respective boards;

FIG. 12 is a top view showing an arrangement in which a plurality of photoelectric conversion modules are disposed vertically with respect to board ends;

FIG. 13 is a sectional view showing a case in which an light transmission member is composed of a flat optical waveguide;

FIG. 14 is a perspective view showing a case in which the wavelength multiplexer/demultiplexer is composed of an array waveguide grating (AWG);

FIG. 15 is a perspective view showing a waveguide insertion type wavelength multiplexer/demultiplexer using a multilayer film filter; and

FIG. 16 is a sectional view showing a conventional array light interface module.

### REFERENCE NUMERALS

201 multiwavelength VCSEL
202 wavelength multiplexing filter
301 board
304 driver IC
305 optical connector
306 fiber sheet
307 two-dimensional array-shaped optical connector
308-1, 308-2, 308-3 a plurality of photoelectric conversion modules having an oscillation wavelength which are different in a module unit
309-1, 309-2, 309-3 a plurality of VCSEL arrays having a different oscillation wavelength in a module unit
310 one dimensional parallel optical signal
311 wavelength multiplexer/demultiplexer
312 PMLA
313 multilayer film filter
314 one-dimensional array-shaped optical fiber
315 mirror

### BEST MODE FOR CARRYING OUT THE INVENTION

An embodiment of the present invention will be described below in detail with reference to the accompanying figures.

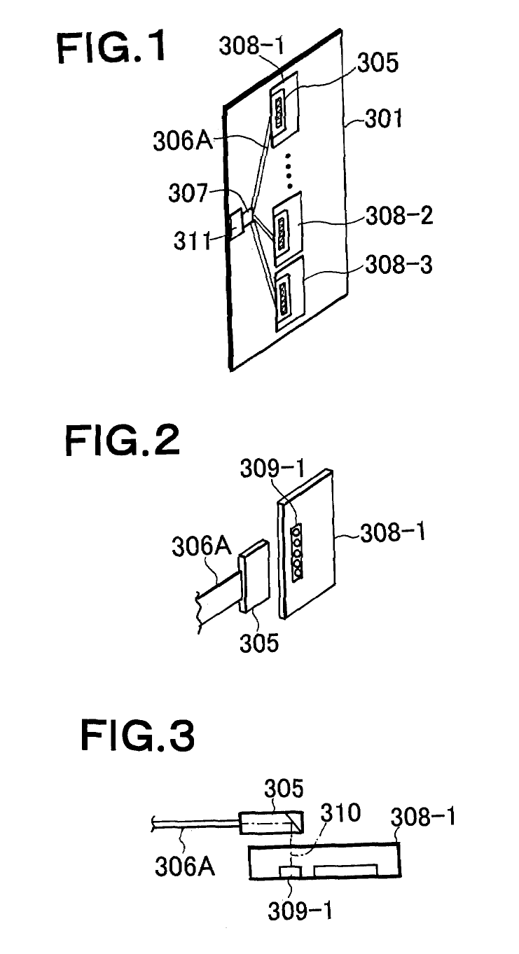

FIG. 1 to FIG. 8 are arrangement views showing a schematic structure of the embodiment of the present invention. FIG. 1 is a perspective view of an overall optical communication module according to the present invention. One or more one-dimensional array-shaped photoelectric conversion modules 308-1, 308-2, 308-3 are disposed on a board 301. Although FIG. 1 shows the three photoelectric conversion modules 308-1, 308-2, 308-3, one or more photoelectric conversion modules may be disposed. FIG. 2 shows a perspective view of the one-dimensional array-shaped photoelectric conversion module 308-1, and FIG. 3 shows a sectional view thereof.

A one-dimensional VCSEL array 309-1 having a single wavelength and an IC driver 304 electrically connected to the VCSEL array 309-1 are mounted in the one-dimensional array-shaped photoelectric conversion module 308-1. It is preferable that the VCSEL array 309-1 is a monolithic integrated array from a point of view of mounting cost and mounting accuracy. Further, a VCSEL array 309-2 (not shown) is mounted on the photoelectric conversion module 308-2, and a VCSEL array 309-3 (not shown) is mounted on the photoelectric conversion module 308-3, and they are composed similarly to the one-dimensional array-shaped photoelectric conversion module 308-1. The one-dimensional array-shaped photoelectric conversion module 308-1 is optically connected to a fiber sheet 306 having mechanical flexibility through an optical connector 305 that can bend an optical path at an approximately right angle (including a right angle and the range of angle near to a right angle in view of dispersion and the like in production). Note that although the optical connector 305 that can bend the optical path at an approximately right angle is used here because light is emitted from the VCSEL array 309-1 onto the surface of a substrate (board) 301 in a vertical direction. However, when light is emitted therefrom in parallel with the substrate surface, or the fiber sheet 306 is disposed in the vertical direction with respect to the substrate surface, the optical connector 305 need not be used. The fiber sheet 306 includes a plurality of optical fibers 306A sandwiched between sheets and bonded thereto by an adhesive and has the plurality of optical fibers 306A in a part thereof as shown in FIG. 8. FIG. 1 to FIG. 4 show only the plurality of optical fibers 306A of the fiber sheet 306.

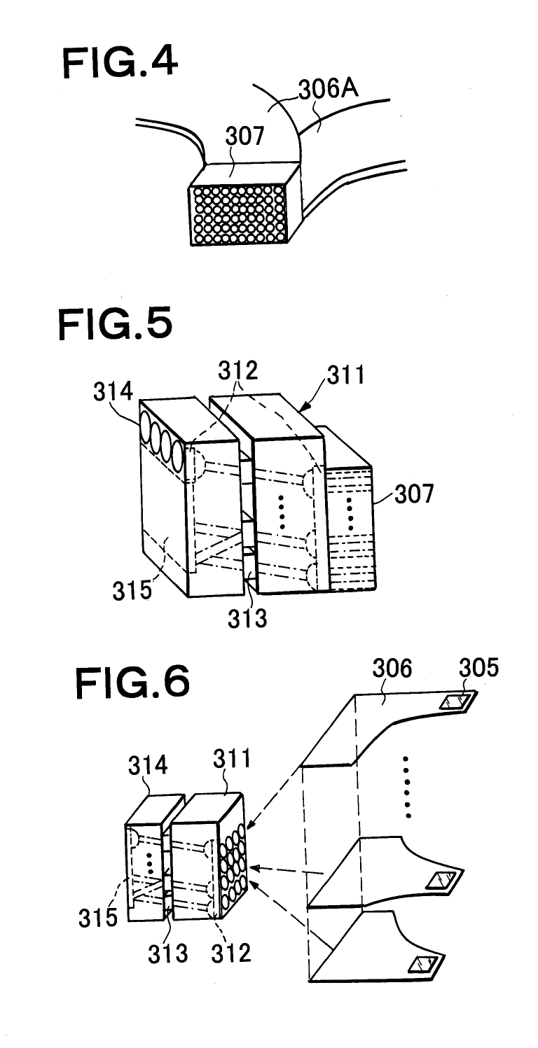

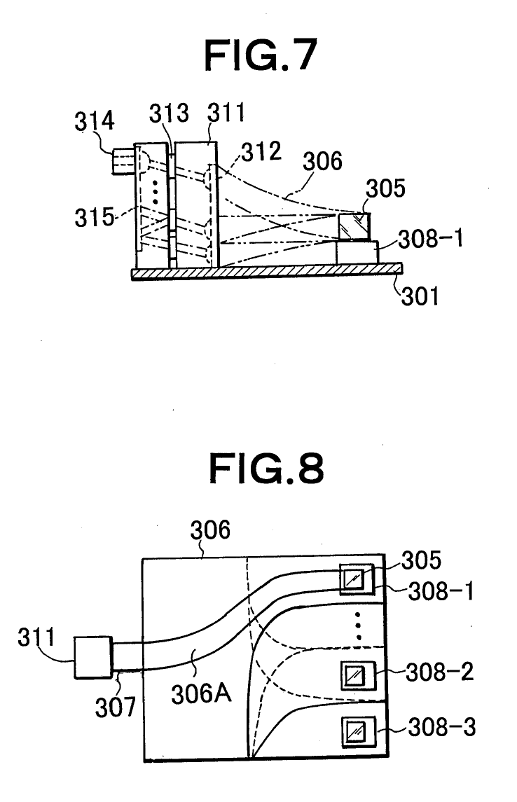

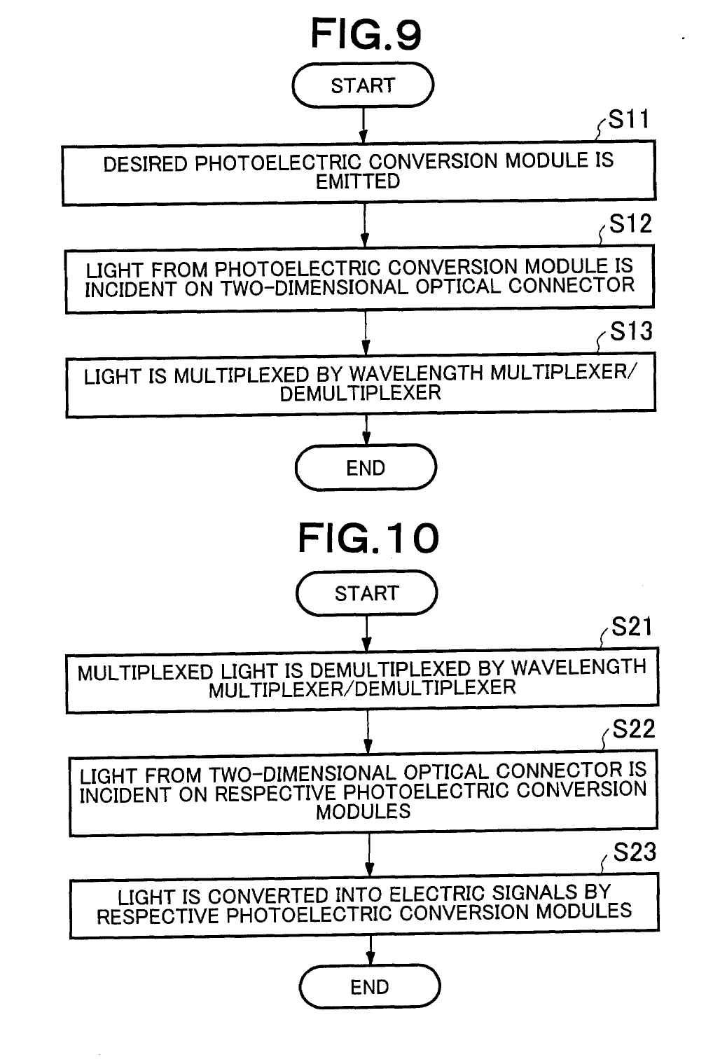

As the fiber sheets 306, which extend from the one-dimensional array-shaped photoelectric conversion modules 308-1 to 308-3, approach to an end of the board 301, they are laminated (piled up) with each other and connected to a two-dimensional array-shaped optical connector 307 at the board end as shown in FIG. 4. A wavelength multiplexer/demultiplexer 311 is connected to the two-dimensional array-shaped optical connector 307. FIG. 4 shows that the plurality of optical fibers 306A connect to the optical connector 307. As shown in FIG. 5, the wavelength multiplexer/demultiplexer 311 includes a PMLA (Planer Micro Lens Array) 312, multilayer film filters 313 as many as the number of wavelengths, and a mirror 315. FIGS. 6, 7, and 8 show an arrangement view, a sectional view, and a top view of an overall optical communication module, respectively. Note that although the optical connector 307 is omitted in FIGS. 6 and 7, actually, the light from the fiber sheet 306 is input to the wavelength multiplexer/demultiplexer 311 through the optical connector 307. FIG. 9 is a flowchart showing an optical signal transmission method of generating optical signals having a different wavelength and outputting them after multiplexing them. The wavelength multiplexer/demultiplexer using the multilayer film filter is described in http://www.omron.co.jp/ecb/products/opt/1/p1x4a.html.

The parallel electric signals formed by the driver IC 304 are input to the respective VCSEL arrays 309-1 and are subjected to photoelectric conversion. The driver IC 304 disposed to each of the photoelectric conversion modules is controlled by a not shown controller disposed on the board 301, and causes all of or a part of the VCSEL arrays to emit light, in all of or a part of the photoelectric conversion modules on the board 301 (step S11 of FIG. 9). The light path of the parallel optical signal 310 emitted from VCSEL array 309-1 is bent at a right angle by a corner mirror 305 and transmits through the fiber sheet 306 acting as an light transmission member. Optical signals having a different wavelength transmit through the respective fiber sheets from the one-dimensional array-shaped photoelectric conversion modules 308-1 to 308-3. The respective fiber sheets 306 are laminated (piled up) with each other, and connected to one end (here, an input end) of the two-dimensional array-shaped optical connector 307 (step S12 of FIG. 9). The optical signal from the other end (here, a light outgoing end) of the optical connector 307 is incident on the wavelength multiplexer/demultiplexer 311. The optical signals incident on the wavelength multiplexer/demultiplexer 311 are collimated by the PMLA 312 and are incident on multilayer film filters 313 designed to respective wavelengths in use. The multilayer film filters 313 are designed to transmit only the optical signals having the respective wavelengths and to reflect the optical signals having wavelength other than the above wavelengths. The optical signals are multiplexed by making use of the characteristics of the multilayer film filters 313, the two-dimensional array-shaped light outgoing end is finally changed to one-dimensional array-shaped light outgoing end and connected to a one-dimensional array-shaped optical connector (step S13 of FIG. 9). With this arrangement, the optical communication module acts as an array light interface transmission module.

With this arrangement, since the mounting shape in photoelectric conversion module 308 is the one dimensional array shape, it has a high degree of freedom of layout and further can be replaced in a unit of one dimensional array. Further, since the one-dimensional array-shaped photoelectric conversion modules 308-1 to 308-3 can be flexibly disposed, wirings and heat dissipation can be designed with a high degree of freedom in consideration of electric crosstalk. Further, since the one-dimensional array-shaped photoelectric conversion module is connected to the connector 305 using the above arrangement, a dead space required when an ordinary MT connector (Mechanically Transferable Connector) is inserted and extracted can be omitted, thereby space-saving mounting can be realized. Further, in the wavelength multiplexer/demultiplexer 311 having a two-dimensional array shape at the board end, the wavelengths which are different from each other in a unit of module are multiplexed and connected to a one-dimensional optical fiber 314 through an optical connector.

With this arrangement, it is possible to simply transmit signals whose wavelengths are multiplexed, in parallel with each other. The plurality of one-dimensional array-shaped photoelectric conversion modules correspond to the optical signals having a different wavelength. When, for example, the wavelength of the optical signal from the photoelectric conversion module 308-1 is represented by λ1, the wavelength of the optical signal from the photoelectric conversion module 308-2 is represented by λ2, and the wavelength of the optical signal from the photoelectric conversion module 308-3 is represented by λ3 (the wavelengths λ1, λ2, and λ3 a different from each other, these wavelengths λ1 to λ3 are output after they are multiplexed. Note that the photoelectric conversion modules need not necessarily have a single wavelength. That is, to permit the photoelectric conversion modules to transmit a plurality of wavelengths when necessary, the respective photoelectric conversion modules can be designed and transmit optical signals. For example, it is possible that the optical signal from photoelectric conversion module 308-1 has the wavelengths λ1 and λ2, the optical signal from the photoelectric conversion module 308-2 has the wavelengths λ3 and λ4, and the optical signal from the photoelectric conversion module 308-3 has the wavelengths λ5 and λ6 (the wavelengths λ1 to λ6 are different from each other, respectively). In this case, the multilayer film filters 313 are appropriately designed to the plurality of wavelength signals from the photoelectric conversion module. As described above, even if the plurality of wavelengths are transmitted from the photoelectric conversion module, since the optical signals having the different wavelength are transmitted as they are divided into the plurality of photoelectric conversion modules, the photoelectric conversion modules can be replaced individually. Consequently, the photoelectric conversion modules can be more easily manufactured than a conventional case in which the multiwavelength monolithic integrated VCSEL that carries out a collective growth on the same substrate is used.

The VCSEL array 309 of each photoelectric conversion module may be displaced with a PD (Photo Detector) array. In this case, the signal flows in a direction opposite to that of the VCSEL array, and the PD array acts as an array light interface receiving module. FIG. 10 is a flowchart showing an optical signal transmission method of demultiplexing a multiplexed optical signal and outputting it to one-dimensional array-shaped photoelectric conversion module. That is, the optical signal multiplexed by the wavelength multiplexer/demultiplexer 311 is demultiplexed (step S21) and is incident on the PD array through the optical connector 307, the fiber sheet 306, the optical connector 305 (step S22), and the electric signal subjected to photoelectric conversion by the PD array is sent to the driver IC 304 (step S23).

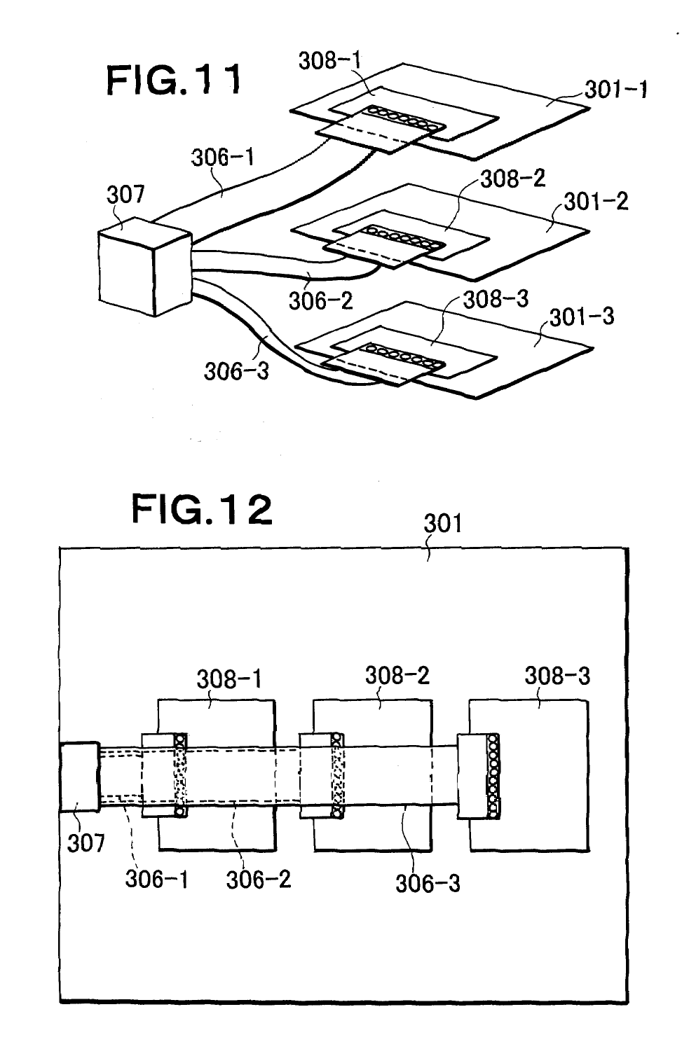

The VCSEL array 309 may be mounted in the photoelectric conversion module 308 in mixture with the PD array. In this case, the photoelectric conversion module 308 acts as an array light transmitting/receiving module. That is, when the VCSEL array 303 and the PD array are mounted in one photoelectric conversion module, the number of channels per one photoelectric conversion module is set to ten channels as shown in FIG. 4, and each five channels are allocated to the VCSEL array 303 and the PD array, respectively, the photoelectric conversion module can have five channels for transmission and five channels for reception. Note that FIGS. 5 and 6 show four channels, and FIG. 11 described below shows seven channels for the purpose of simplification.

The photoelectric conversion modules 308-1 to 308-3 may be separately disposed on a plurality of boards. In this case, the fiber sheets 306 from the photoelectric conversion modules 308-1 to 308-3 on the plurality of boards are gathered to the one two-dimensional array-shaped optical connector 307 and connected thereto. That is, the embodiment invention is not limited to the case in which the plurality of photoelectric conversion modules 302 are mounted on the one board as shown in FIG. 1, and the photoelectric conversion modules 308-1 to 308-3 mounted on respective boards 301-1 to 301-3 may be connected to the two-dimensional array-shaped optical connector 307 through mechanically flexible fiber sheets 306-1 to 306-3 as shown in FIG. 11. In FIG. 11, the wavelength multiplexer/demultiplexer 311 is omitted for the purpose of simplification.

Further, as a method of disposing the photoelectric conversion module 308, although the photoelectric conversion modules 308 are disposed in parallel with the board end of in FIG. 1, they may be disposed in a vertical direction with respect to the board end. For example, as shown in FIG. 12, the photoelectric conversion module 308-1 to 308-3 may be disposed vertically with respect to the board end of the board 301, and the fiber sheets 306-1 to 306-3 may be overlapped on the board 301 and connected to the two-dimensional array-shaped optical connector 307. The wavelength multiplexer/demultiplexer 311 is omitted in FIG. 12 for the purpose of simplification.

An optical modulator may be built in the one-dimensional array-shaped photoelectric conversion module 308. In this case, the photoelectric conversion module acts as a photoelectric conversion module that can deal with a higher bit rate as compared with a case in which no optical modulator is built in.

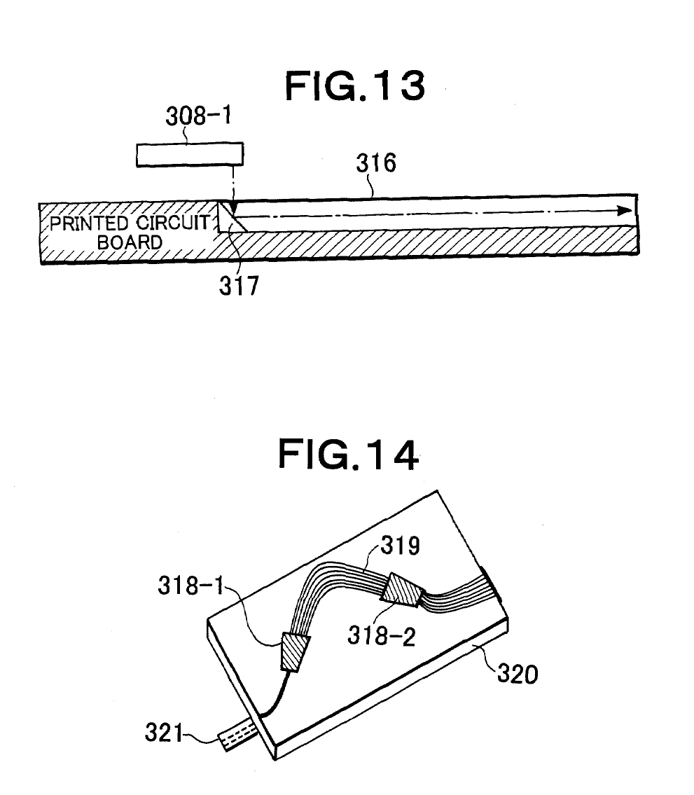

The fiber sheet 306 may be displaced with a tape fiber. The tape fiber is formed by disposing a plurality of optical fibers and bonding them with an adhesive. The fiber sheet 306 may be displaced with a flat optical waveguide. FIG. 13 is a sectional view showing a case in which an light transmission member is composed of a flat optical waveguide. The flat optical waveguide 316 is formed on a print circuit board. An end of the flat optical waveguide 316 is caused to act as a 45° inclined mirror 317. The light emitting portion and/or the light receiving portion of the one-dimensional array-shaped photoelectric conversion module 308-1 faces the surface of the print board (in the lower direction in the figure) and the module 308-1 is mounted in contact with the upper surface of the optical waveguide acting as a reference surface. The light emitted from the one-dimensional array-shaped photoelectric conversion module is incident on the flat optical waveguide from the upper surface thereof, is reflected on the 45° inclined mirror 317, is incident on the flat surface optical waveguide 316, and is guided to the two-dimensional array-shaped optical connector 307 connected to the flat optical waveguide. Japanese Patent Application Laid-Open No. 2003-215371 discloses a flat optical waveguide arranged as described above.

The wavelength multiplexer/demultiplexer 311 may be composed of a diffraction grating. Otherwise, the wavelength multiplexer/demultiplexer 311 may be composed of a fiber type coupler, a fiber type WDM filter, and the like. Further, the wavelength multiplexer/demultiplexer 311 may be composed of an array waveguide grating.

FIG. 14 is a perspective view showing a case that the wavelength multiplexer/demultiplexer is composed of the array waveguide grating (AWG). A multiplexed optical signal is input from an optical fiber 321, and the wavelength of the multiplexed optical signal is demultiplexed through a slab optical waveguide 318-1, an array waveguide 319 and a slab optical waveguide 318-2 that are formed on a silicon substrate 320, and the demultiplexed optical signals are incident on the optical connector 307. The AWG is described in http://www.phlab.ecl.ntt.co.jp/theme/No_{—}01/t_{—}1.html. A plurality of AWGs are overlapped with each other and connected to the two-dimensional optical connector 307. When, for example, the wavelength of the optical signal from the photoelectric conversion module 308-1 including the VCSEL array shown in FIG. 1 is represented by λ1, the wavelength of the optical signal from the photoelectric conversion module 308-2 including the VCSEL array is represented by λ2, and the wavelength of the optical signal from the photoelectric conversion module 308-3 including the VCSEL array is represented by λ3, the optical signals (having the wavelengths λ1, λ2, λ3, respectively) from the photoelectric conversion modules 308-1 to 308-3 are input to the slab optical waveguides 318-2 on the plurality of overlapped silicon substrates 320, and these wavelengths λ1 to λ3 are output from the optical fibers 321 through the slab optical waveguides 318-1 on the silicon substrates 320 after they are multiplexed.

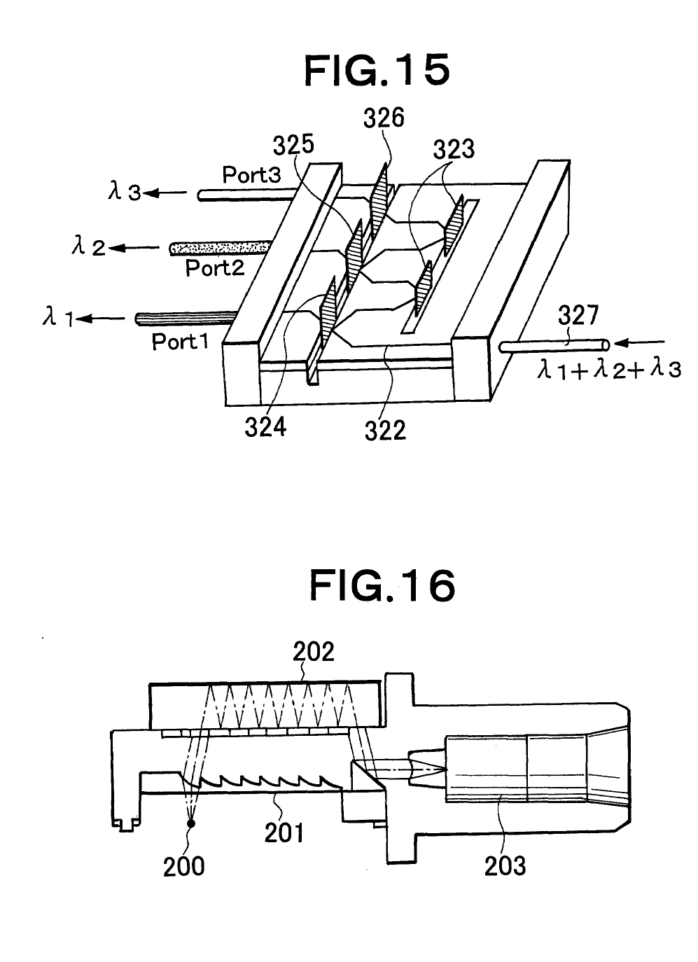

FIG. 15 is a perspective view showing a waveguide insertion type wavelength multiplexer/demultiplexer using multilayer film filters. As shown in FIG. 15, the waveguide insertion type wavelength multiplexer/demultiplexer using the multilayer film filter inputs light to a waveguide instead of collimating light and transmitting the collimated light in a space. Wavelengths are allocated to the respective ports of a substrate such as a silicon optical waveguide substrate or a polyimide optical waveguide substrate, and multilayer film filters 324, 325 and 326 for the wavelengths λ1 to λ3 are inserted into the optical waveguide 322 (groove of the substrate) of the substrate. As shown in FIG. 15, when a multiplexed optical signal having wavelengths λ1+λ2+λ3 is input to one port through an optical fiber 327, demultiplexed wavelengths λ1, λ2, λ3 are output from the other ports, output to a two-dimensional optical connector 307, and then output to respective photoelectric conversion modules each including a PD array. A plurality of substrates are overlapped and connected to the two-dimensional optical connector 307. Thus, the wavelength λ1, λ2, λ3 are output from the respective substrates, and, for example, the light having the wavelength λ1 is input to a photoelectric conversion module 308-1 including the PD array, the light having the wavelength λ2 is input to a photoelectric conversion module 308-2 including the PD array, and the light having the wavelength λ3 is input to a photoelectric conversion module 308-3 including the PD array.

1. An optical communication module comprising:
a plurality of one-dimensional array-shaped photoelectric conversion modules;
a plurality of light transmission members optically connected to the plurality of one-dimensional array-shaped photoelectric conversion modules; and
a two-dimensional array-shaped optical connector whose one connector end is optically connected to the plurality of light transmission members,
wherein the plurality of one-dimensional array-shaped photoelectric conversion modules correspond to optical signals having respective different wavelengths, and the other connector end of the two-dimensional array-shaped optical connector is optically connected to a wavelength multiplexer/demultiplexer.

2. The optical communication module according to claim 1, wherein the plurality of light transmission members have a laminated structure.

3. The optical communication module according to claim 1, wherein the plurality of one-dimensional array-shaped photoelectric conversion modules are disposed on the same board.

4. The optical communication module according to claim 1, wherein the plurality of one-dimensional array-shaped photoelectric conversion modules are disposed on a plurality of boards.

5. The optical communication module according to claim 1, wherein at least one of the one-dimensional array-shaped photoelectric conversion modules includes a light emitting element.

6. The optical communication module according to claim 1, wherein at least one of the one-dimensional array-shaped photoelectric conversion modules includes a light receiving element.

7. The optical communication module according to claim 1, wherein at least one of the one-dimensional array-shaped photoelectric conversion modules includes both a light emitting element and a light receiving element.

8. The optical communication module according to claim 1, wherein the one-dimensional array-shaped photoelectric conversion modules are optically connected to the light transmission members through a second optical connector.

9. The optical communication module according to claim 8, wherein the second optical connector is a connector which can bend an optical path at an approximately right angle.

10. The optical communication module according to claim 1, characterized in that the light transmission member is composed of a fiber sheet.

11. The optical communication module according to claim 1, wherein the light transmission member is composed of a tape fiber.

12. The optical communication module according to claim 1, wherein the light transmission member is composed of a flat optical waveguide.

13. The optical communication module according to claim 1, wherein the wavelength multiplexer/demultiplexer includes a multilayer film filter.

14. The optical communication module according to claim 1, wherein the wavelength multiplexer/demultiplexer is composed of an array optical waveguide grating.

15. The optical communication module according to claim 5, wherein the light emitting element of the one-dimensional array-shaped photoelectric conversion module is a VCSEL array.

16. The optical communication module according to claim 1, wherein the one-dimensional array-shaped photoelectric conversion module corresponds to an optical signal of a single wavelength.

17. An optical signal transmission method, comprising the steps of:
demultiplexing an optical signal having a different wavelength by a wavelength multiplexer/demultiplexer optically connected to one connector end of a two-dimensional array-shaped optical connector; and
outputting the demultiplexed outputs from the other end of the two-dimensional array-shaped optical connector to a plurality of one-dimensional array-shaped photoelectric conversion modules.

18. An optical signal transmission method, comprising the steps of:
inputting optical signals having a different wavelength from a plurality of one-dimensional array-shaped photoelectric conversion modules to one end of a two-dimensional array-shaped optical connector; and
modulating the optical signals by a wavelength multiplexer/demultiplexer optically connected to the other end of the two-dimensional array-shaped optical connector and outputting the modulated optical signal.
